(19) United States
(12) Patent Application Publication
(10) Pub. No.: US 2015/0120545 A1
(43) Pub. Date: Apr. 30, 2015

(54) NON-COMPLIANT PAYMENT CAPTURE SYSTEMS AND METHODS

(71) Applicant: JPMorgan Chase Bank, N.A., New York, NY (US)

(72) Inventors: Ernest John Fiore, Florham Park, NJ (US); Gary Joura, New York, NY (US); Timothy J. Hamilton, New York, NY (US)

(73) Assignee: JPMorgan Chase Bank, N.A., New York, NY (US)

(21) Appl. No.: 14/064,794

(22) Filed: Oct. 28, 2013

(51) Int. Cl. G06Q 20/40

(52) U.S. Cl. CPC G06Q 20/405
USPC 705/44

(57) ABSTRACT

Embodiments of the present invention are generally directed to detection of non-compliant payment requests or payment orders. In particular, the invention detects non-compliance with travel rules put in place by multiple countries throughout the world. The systems and methods for capturing non-compliant payments may be adapted for various funds transfer channels or systems, including but not limited to Society for Worldwide Interbank Financial Telecommunication (SWIFT), Federal Reserve Wire Network or FedWire, Clearing House Interbank Payments System (CHIPS), or other public or proprietary funds transfer or payment systems.

### FIELD OF THE INVENTION

The present invention relates generally to financial processing, and more particularly, to a system and method for capturing non-compliant payment transactions.

### BACKGROUND OF THE INVENTION

After the September 11 attacks, the international banking community have responded to concerns of money laundering and the financing of acts of terrorism by passing anti-money laundering and counter-terrorist financing (AMT/CTF) regulations. Examples of global or country-specific AMT/CTF regulations, also known in the payment industry as “travel rules,” include International Standards on Combating Money Laundering And The Financing of Terrorism & Proliferation, The FATF Recommendations (February 2012) and Proceeds of Crime (Money Laundering) and Terrorist Financing, Canada (June 2009). These regulations typically require a payment order to have complete transmitter information, and, in some cases, specific recipient information in order to be considered a compliant payment. Payments without such requisite information are being delayed or returned as non-compliant payments by banks around the globe.

The travel rules are designed to help with the prevention, detection, and investigation of money laundering and other financial crimes by preserving an information trail about persons sending and receiving funds through funds transfer systems. While not all countries have adopted AMT/CTF regulations, many already have specific travel rules and many more are expected to implement them. The types of information required by the rules may include, for example the full legal name, account number, and physical address of the transmitter, identity of the transmitter's financial institution, he amount of the transmittal order, execution date, and identity of the recipient's financial institution. Other information such as account number of the recipient and the address of the recipient may also be required.

While each country may require similar information to be included in the request, the exact content and expected format of the content vary from country to country. If requestors fail to comply by providing the required content and following the required format, then the requestors and the financial institution transmitting the requests may both be penalized for non-compliance.

Currently, tools for monitoring the formatting of payments and to assist customers to comply with global payment formatting regulations are lacking or insufficient. For example, FIG. 1 shows a diagram illustrating a prior approach for processing payment orders where the originating bank (“Bank 1”) would do little or no screening of payment orders to check their compliance with travel rules (or conduct inefficient, manual screening) before forwarding the payments to the destination bank (“Bank 2”). Due to the aforementioned proliferation of different travel rules in different foreign jurisdictions, a significant percentage of cross-border payments may fail to comply with the applicable formatting rules. When a non-compliant payment order is caught by Bank 2, the destination bank, or a banking regulator, the payment order may not be executed and is instead returned to Bank 1, the originating bank, which would have to invest the time, cost, and labor to investigate and correct the non-compliant payment data. The investigation and correction may have to involve the ordering party who submitted the payment order. The corrected payment order (or a new, replacement order) may be sent to Bank 2 again for execution. Only if the payment order has become compliant will it be executed by Bank 2 whereupon cash or credit may be given to the beneficiary. It can be appreciated that the prior payment processing approach failed to monitor or screen payment orders for travel rule compliance in an efficient and effective manner.

Accordingly, a system is needed for monitoring format compliance and formulating output designed to correct the non-compliance. Thus, embodiments of the invention proactively identify payments that will fail specific country regulations governing information required on payments. Customers can be identified and can be given an opportunity to correct/amend the payment before it is sent on to the beneficiary account's country of residence.

Other problems and drawbacks also exist.

### SUMMARY OF THE INVENTION

Accordingly, it is one object of the present invention to overcome one or more of the aforementioned and other limitations of existing systems and methods for payment processing by providing capabilities of automatically capturing non-compliant payment orders by screening payment data against relevant travel rules.

It is another object of the present invention to efficiently detect and correct non-compliant payment orders so as to reduce costs for managing investigations and to improve payment success rates. Implementation of embodiments of the present invention is also expected to reduce reputational risk with correspondent banks and regulators.

It is yet another object of the present invention to improve client experience by reducing delay of end-to-end payment execution and lowering risk of returns.

Accordingly, one particular embodiment of the present invention comprises a computer-implemented method for capturing non-compliant payments. The method may comprise compiling, into an electronic database, a plurality of travel rules governing requisite information of payments to at least one foreign jurisdiction. The method may also comprise receiving, by at least one computer processor, payment data concerning a payment order, the payment order requesting a payment from an ordering party to a beneficiary. The method may further comprise determining, by the at least one computer processor, whether the payment data comply with the plurality of travel rules, by determining, in the payment data, a presence or absence of one or more data elements required by at least one of the plurality of travel rules or by determining whether a data element in the payment data meets a content or formatting requirement of at least one of the plurality of travel rules. The method may additionally comprise generating an output based on the step of determining whether the payment data comply with the plurality of travel rules.

Additional features and advantages of the invention will be set forth in the description that follows, and in part will be apparent from the description, or may be learned by practice of the invention.

### BRIEF DESCRIPTION OF THE DRAWINGS

The accompanying drawings are included to provide a further understanding of the invention and are incorporated in and constitute part of this specification, illustrate several embodiments of the invention and, together with the description, serve to explain the principles of the invention. The purpose and advantages of the present invention will be apparent to those of skill in the art from the following detailed description in conjunction with the appended drawings wherein:

FIG. 1 is a diagram illustrating a prior approach for processing payment orders;

FIG. 2 is a diagram illustrating an exemplary method for processing and screening payment orders for compliance with travel rules according to embodiments of the present invention;

FIG. 3 is a flowchart illustrating an exemplary method for capturing non-compliant payment orders in accordance with one embodiment of the present invention;

FIG. 4 is a diagram illustrating an exemplary method for examining data elements of a payment order against travel rules in accordance with one embodiment of the present invention;

FIG. 5 is a block diagram illustrating an exemplary system for capturing non-compliant payment orders in accordance with one embodiment of the present invention; and

FIG. 6 is a block diagram illustrating an exemplary compliance server in accordance with one embodiment of the present invention.

### DETAILED DESCRIPTION OF THE INVENTION

Embodiments of the present invention are generally directed to detection of non-compliant payment requests or payment orders. In particular, the invention detects non-compliance with travel rules put in place by multiple countries throughout the world. The systems and methods for capturing non-compliant payments may be adapted for various funds transfer channels or systems, including but not limited to Society for Worldwide Interbank Financial Telecommunication (SWIFT), Federal Reserve Wire Network or FedWire, Clearing House Interbank Payments System (CHIPS), or other public or proprietary funds transfer or payment systems.

According to embodiments of the invention, a system may include a database that stores individual country rules. The database may be periodically updated to incorporate newly instituted rules. A computer processor determines which rules should be applied and applies the selected rules to payment orders to detect those that are not in full compliance with the selected travel rules.

The computer processor may perform a line-by-line comparison to identify discrepancies between the submitted information and expected information. When non-compliance is detected, the system may provide an alert and a request for correction. Embodiments of the invention may provide an interface through which a payment requester can ensure accuracy during input of the payment request. Non-compliant information may be flagged until the system determines that the information has been corrected to become compliant. Alternatively, after submission of a payment order, the system operates on the payment data to detect non-compliance and send alerts.

Generally, if a non-compliant payment request is processed, it can result in delays, penalties, and in some instances, a returned payment. Accordingly, a system of the present invention may provide a notification to requestors that enables them to correct their current and future requests for compliance in order to avoid these penalties, delays, and returned payments.

The alerts generated by the system, may include an error code or other identifier of error type. Furthermore, reports may be generated to notify requestors of collective error statistics and the regulations violated. These reports may enable larger-scale detection and correction of recurring non-compliant formats. In addition to reports and alerts, repair opportunities may be provided, so that delays and penalties for the current payment request can be avoided.

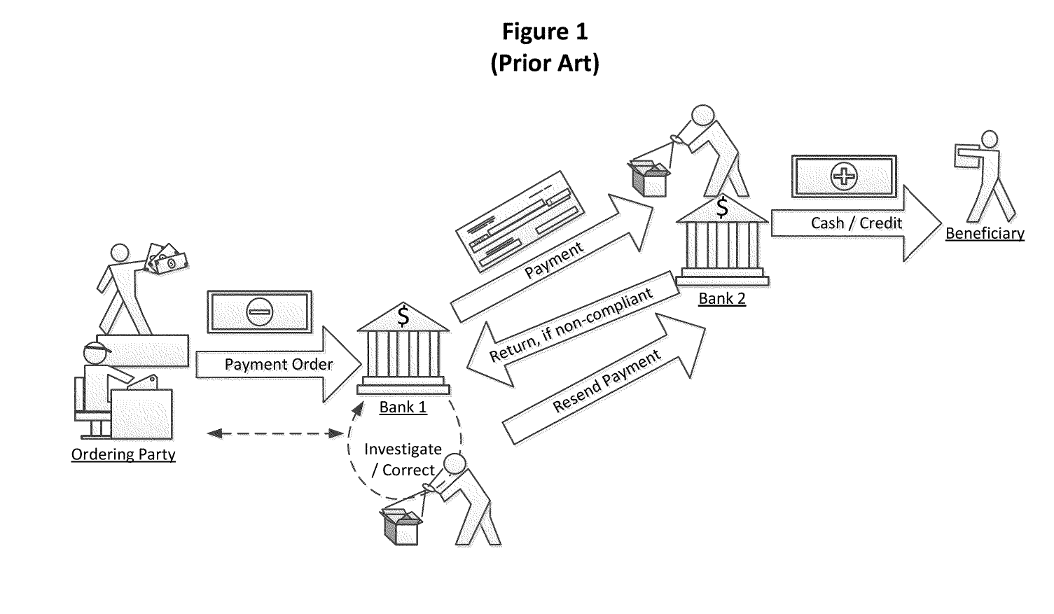

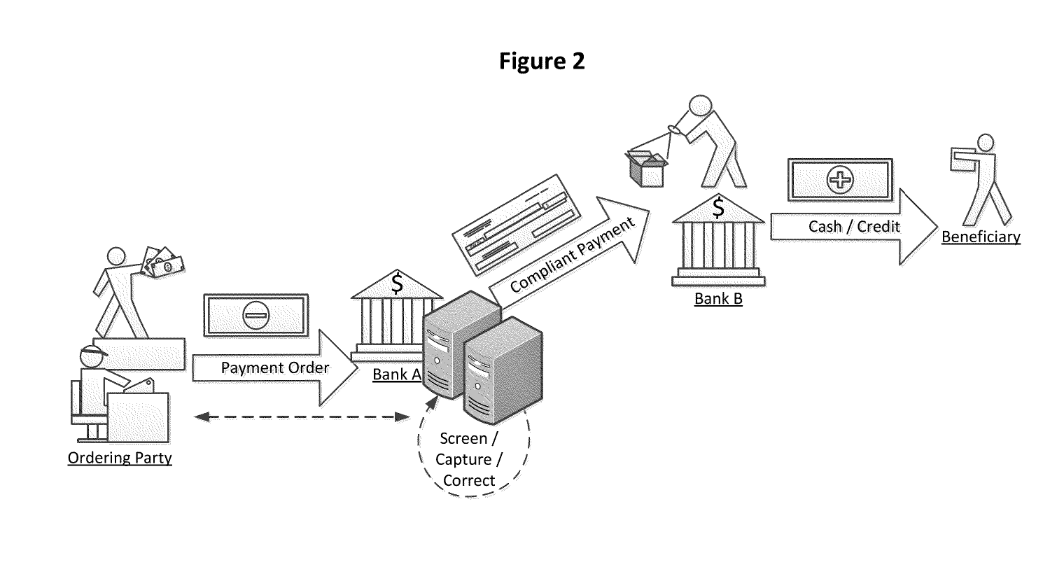

FIG. 2 is a diagram illustrating an exemplary method for processing and screening payment orders for compliance with travel rules according to embodiments of the present invention. In contrast to the prior approach shown in FIG. 1, FIG. 2 shows an originating bank (“Bank A”) that proactively screens incoming payment orders, based on applicable travel rules, to capture and correct those having non-compliant payment data. The screening is performed by one or more computer processors based on a database of compiled travel rules. After the screening, only compliant (or substantially compliant) payments are forwarded to the destination bank (“Bank B”), thereby reducing the instances of non-compliance or returns and increasing the chances of the payments getting executed on the first attempt.

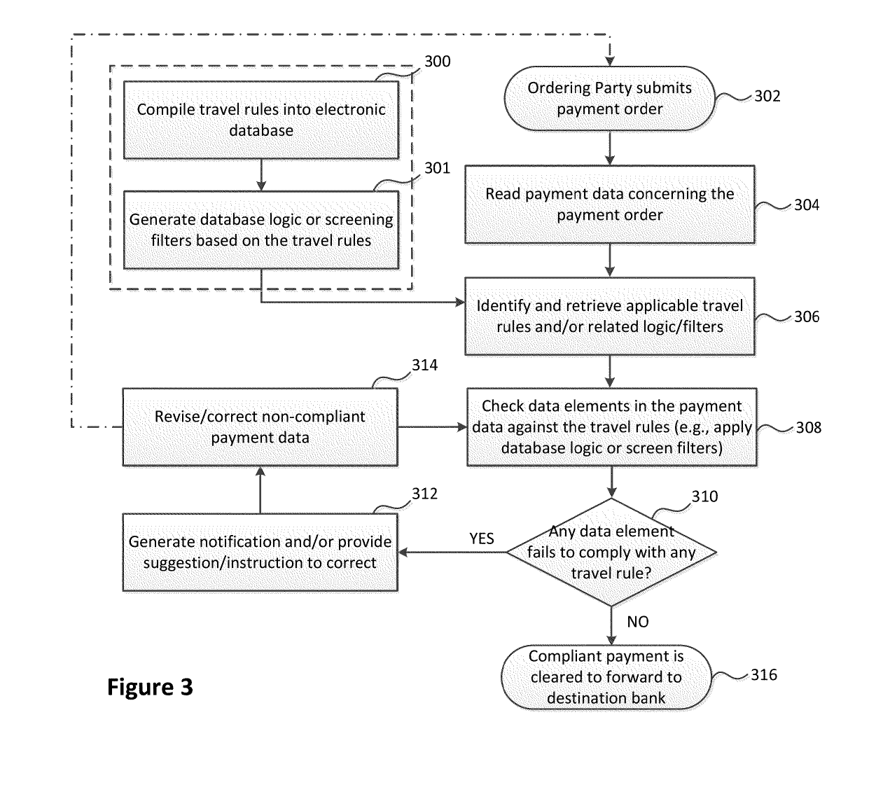

FIG. 3 is a flowchart illustrating an exemplary method for capturing non-compliant payment orders in accordance with one embodiment of the present invention.

In Step 300, a payment processing entity, such as a bank or other financial institution, may compile travel rules into an electronic database. The travel rules may include multiple sets of AMT/CTF-related regulations issued by different jurisdictions such as countries, territories, or regions around the globe. These travel rules may comprise specific requirements for the content and format of payment data that must accompany payment orders. The rules may further include outbound rules governing payments leaving a jurisdiction and inbound rules governing payments entering the jurisdiction.

According to some embodiments of the present invention, the travel rules may be obtained from the respective local authorities who issued the rules and may be parsed by human or by computer into individual sub-rules specifying requirements for data elements in payment data. For example, the compiled travel rules may be organized into a table that lists required and optional data fields expected for a payment order as well as the corresponding content and/or formatting requirements. Typical data elements may include full name of ordering party, full name and address of beneficiary, International Bank Account Number (IBAN) or other account identifiers of ordering party and/or beneficiary, and purpose of payment, etc.

In Step 301, database logic or screening filters may be preferably generated based on the compiled travel rules. Although it is possible to simply use the travel rules database to screen payment orders, it may be more desirable to generate business logic in or for the travel rules database or predefine screening filters ahead of the time such that the payment orders may be examined for compliance more efficiently with these preset tools.

According to some embodiments, a computer software language may be adapted to accept new travel rules wherein different symbols may be used to represent conditions of interest. A dictionary of program code may be formulated to scan for certain indicia or conditions in payment data. For example, the expected or required format or template of payment orders related to a specific bank, country or region may be sorted into a data construct in the electronic database of travel rules to facilitate comparisons to payment data. According to one embodiment of the present invention, a set of characters may be translated into specific scanning actions looking for specific conditions within a string of characters on the payment record. The combination of these scanning actions may result in a rule that is used to determine if a payment has complied with a country regulation or not. For example, to develop a rule to comply with Canadian regulations there will be several scanning actions linked together to make up a rule or rules that will be applied to the payment record data to determine compliance with the Canadian regulation(s) governing payment content and formatting.

It should be noted that various jurisdictions may occasionally revise their existing travel rules and/or issue additional travel rules. Accordingly, Steps 300 and 301 may be repeated in order to incorporate the most up-to-date rules into the electronic database and business logic.

In Step 302, a customer may submit a payment order. The person requesting the payment is referred to as the “ordering party,” while the intended recipient of the payment is referred to as the “beneficiary.” The ordering party may submit the payment order via a number of alternative channels. For example, the ordering party may use a bank's Internet banking website or online payment portal to request a wire transfer of funds. Or, the ordering party may visit a branch office of a bank or money transfer service provider (e.g., Western Union) to tender cash and request a funds transfer. Alternatively, the ordering party may submit a request form via email or fax.

Regardless of the request channel used by the ordering party, the payment data concerning the payment order may be received and read in Step 304. To the extent they are already in an appropriate electronic format (e.g., as received via the Internet channel or from a branch office computer), the payment data may be imported directly into a computer system for compliance processing. If the payment order is submitted in other forms (e.g., in a PDF format or on a fax sheet), some pre-processing may be required to extract the relevant payment data from the payment order.

Then, in Step 306, the applicable set of travel rules and/or business logic (or screening filters) may be identified and retrieved. The computer system may automatically parse the payment data to identify the relevant jurisdiction(s) (e.g., the payment's to and from countries) and determine which travel rules would be required for the payment order.

In Step 308, the data elements in the payment data may be examined and checked against the applicable travel rules. The computer system may apply the business logic or screen filters to effectively perform an element-by-element or line-by-line comparison between the payment data and applicable travel rules. According to one embodiment of the present invention, every single data element in the payment data may be examined for compliance. According to an alternative embodiment, only selected data elements such as those most critical to the tracing of funds movement may have to be examined.

In Step 310, it may be determined whether any data element in the payment data fails to comply with any travel rule. If one or more data elements are found to be non-compliant (e.g., missing information, incorrect or incomplete data), the computer system may generate an output in Step 312, such as a notification or alert to the ordering party and/or bank personnel. The notification or alert may be delivered via a variety of channels such as server messages, email messages, or text messages. According to a preferred embodiment, one or more suggestions or instructions may be generated and provided to the ordering party and/or bank personnel to correct any non-compliant payment data. According to another embodiment, the order party is notified of any detected non-compliance but the non-compliant payment order may still be processed anyways or if the ordering party fails to amend the payment order within a period of time. According to yet another embodiment, the computer system may follow a predetermined set of business rules to reject or cancel any payment order found to be non-compliant or substantially non-compliant.

In Step 314, the non-compliant payment data may be revised or corrected. The revision or correction process may involve the ordering party, the bank personnel, and/or the computer system. For example, if the ordering party is also a banking customer of the bank processing the payment order, some of the missing or incorrect information (e.g., full legal name, physical address, and IBAN) may be automatically filled in or corrected based on the customer's record(s) maintained in the bank's database(s). Or, the ordering party may be given a period of time to submit a corrected or replacement order with compliant payment data.

The corrected or replacement order may be examined again in Step 308 for compliance with the relevant travel rules (or the order may be treated as a new order so the process branches to Step 302 or Step 304).

If it is determined in Step 310 that all the data elements in the payment data are in full compliance (or in substantial compliance), then the compliant payment is cleared to forward to the destination bank in Step 316.

According to an alternative embodiment of the present invention, the computer system may calculate a compliance score or rating based on its element-by-element examination of the payment data with respect to the applicable travel rules. For example, for a particular set of travel rules or for a particular payment order, the number of non-compliant data elements and/or the types of non-compliance (e.g., missing information versus incomplete/incorrect information) may be tallied to generated a numerical value to quantify the extent of non-compliance. As an alternative to a numerical value, a more qualitative compliance rating may be generated in a similar manner, such as “Severe Non-compliance” (e.g., missing critical information), “Minor Non-compliance” (e.g., non-critical formatting errors), or “Substantial Compliance.” According to one embodiment, the compliance score/rating (or non-compliance score/rating) may weigh the different data elements according to their respective importance to the intended purposes of the travel rules, i.e., to defeat/deter money laundering and terrorist financing. A payment order receiving a compliance score/rating (or non-compliance score/rating) that meets or clears a predetermined threshold may be considered compliant (or non-compliant).

In addition, how strictly or stringently the computer system applies the travel rules to the payment data may be adjusted to a desired level. For example, the compliance processor may be configured to let minor defects slide but be more rigid or exact with more critical data elements.

While the exemplary method illustrated in FIG. 3 is concerned with the processing of a single payment order and its payment data, those skilled in the art would appreciate that this method may be readily adapted to process multiple payment orders in batches. In fact, this payment screening process may be implemented in a variety of manners. For example, the payment orders may be monitored and screened as they are being entered by the ordering customers on a funds transfer portal, such that the customers could get real-time feedback and correct any non-compliant data element before finalizing and submitting the payment orders. Alternatively, the payment orders may be screened as their data are received by a computer system for back office processing of payments. Or, the payment orders may be accumulated by a back office computer system and then screened for compliance in batches.

The outcome of the payment screening process may be recorded and maintained in a database to facilitate the generation of compliance reports and/or for statistical analysis. For example, a banking regulator or auditor may need information on how a bank complies with travel rules and how effective its payment screening process operates. In response to the request, the bank may query the database that maintains records of the payment screening outcome. The queries may pull up specific types of non-compliant payment data with samples and statistics, for instance, identifying all transactions that provided P.O. Box addresses instead of the required physical addresses. The statistical data concerning the various types of compliance failures may also be useful for prioritization and improvement of the business logic or screen filters to better target and capture non-compliances meeting certain patterns.

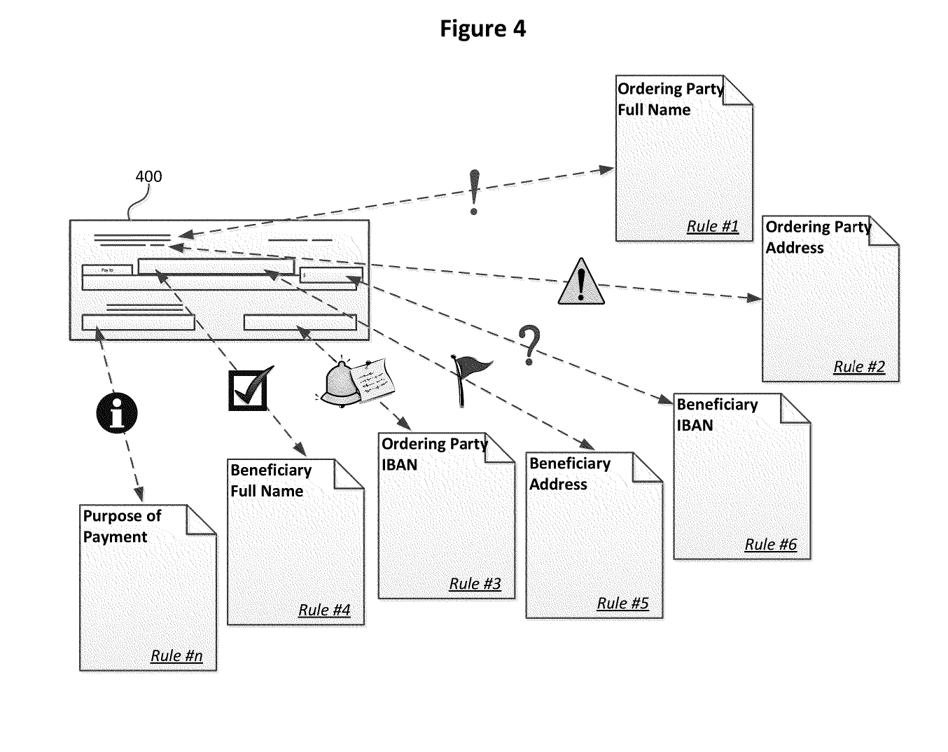

FIG. 4 is a diagram illustrating an exemplary method for examining data elements of a payment order 400 against travel rules in accordance with one embodiment of the present invention. The payment order 400 may have associated therewith payment data having a plurality of data elements in various fields, such as “Ordering Party Full Name,” “Ordering Party Address,” “Ordering Party IBAN,” “Beneficiary Full Name,” “Beneficiary Address,” “Beneficiary IBAN,” “Purpose of Payment,” and so on. Each of these data elements may be parsed by a computer-implemented compliance processor. Corresponding to some or all of these data fields there may be an applicable set of travel rules such as those issued by the country or region to which the payment is addressed.

For example, the Rule #1 may require full legal name of the ordering party which corresponds to a government issued photo ID. A sub-field might require an annotation including the ID type and ID number such as passport and its serial number. The compliance processor may scan the “Ordering Party Full Name” field to confirm presence of entry in each of the Last Name, First Name, and Middle Name sub-fields and/or to detect anticipated characters such as letters and certain special characters (e.g., hyphen and period but not numbers). Lack of full compliance with Rule #1 may be flagged as a critical failure and cause a major warning. A similar screening may be performed on the “Beneficiary Full Name” field.

For another example, Rule #5 may be applied to the “Beneficiary Address” field. The rule may require a full physical address complete with valid sub-fields of street number (instead of P.O. Box number), city name, country name, and postal code. The compliance processor may filter the “Beneficiary Address” data to validate each sub-field against the requirement of Rule #5.

For yet another example, Rule #6 may be applied to the “Beneficiary IBAN” field. The compliance processor may examine the data element in this field to match an expected alphanumerical format and validate the IBAN including country code and check digits. An invalid IBAN entry may be flagged as another critical instance of non-compliance and would require correction.

Some of the rules may comprise strict requirements that must be met while other rules such as “Purpose of Payment” (Rule #n) might be optional or for information only and therefore not subject to as stringent a screening as more critical data elements.

According to some embodiments, the travel rules (or corresponding business logic or screen filters) may be applied in a specific order or sequence. For example, if payment orders of the type being currently processed are statistically more likely to fail a first rule than a second rule, then that first rule or related logic or filter may be applied to the payment order 400 first before the second rule is applied during the screening process. Alternatively, the application of the rules may be prioritized or ordered based on the importance of the rules.

A preferred embodiment of the present invention may include a toolkit or dictionary to build scanning rules specific to the global regulations requirements and identify exceptions to those rules. If a rule states that a specific code is needed in a specific payment field, that rule will be built on-line and then run to look for such exceptions. The rules may be tailored to a specific country as the regulations governing payment formatting differs by country. The rule may indicate that the expected data must begin at a specific location within the string of text, which allows for the enforcement of positional formatting rules, or it can indicate that the expected data must be present anywhere in the text. The rule can indicate that the text must include a specific letter, number or character, or it can check for the presence of any alphabetic character or number. The comparisons can be done on the basis that certain data must be present, or must not be present. There is a minimum of one rule, but there is no maximum number of rules that can be applied. The rules can be changed at any time to meet business needs and those changes may apply immediately.

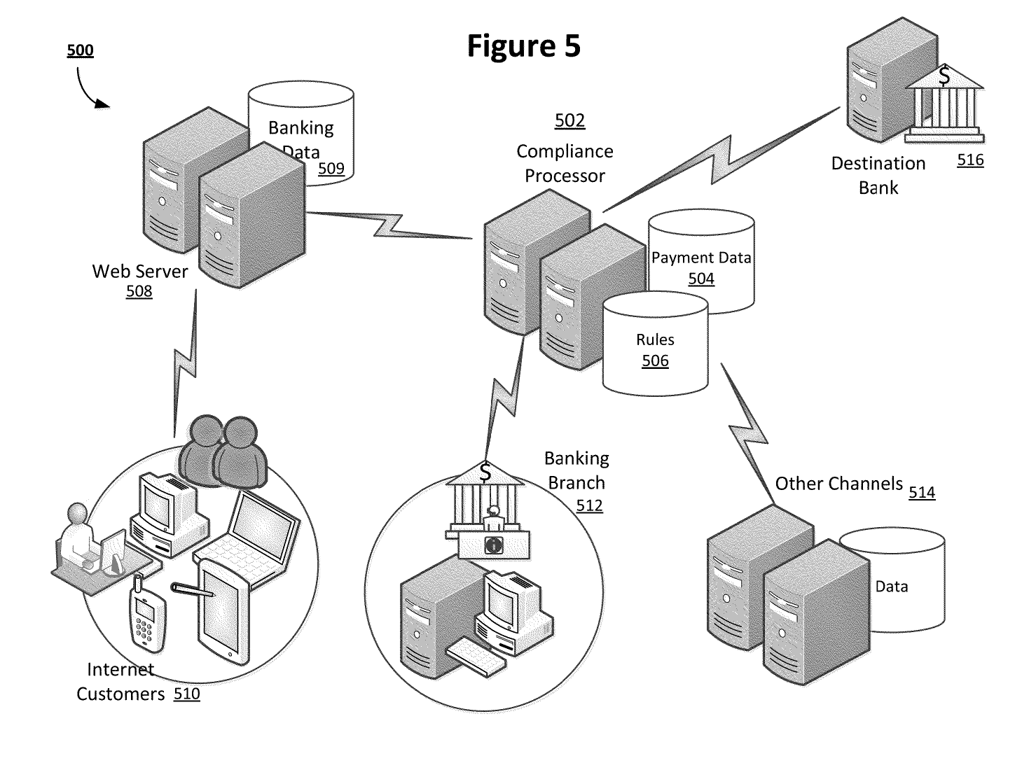

FIG. 5 is a block diagram illustrating an exemplary system 500 for capturing non-compliant payment orders in accordance with one embodiment of the present invention.

As shown, the system 500 (and related software) is implemented based on computing equipment. Generally, it should be noted that the components depicted and described herein may be, or include, a computer or multiple computers. Although the components are sometimes shown as discrete units, they may be interconnected or combined. The components may be described in the general context of computer-executable instructions, such as program modules, being executed by a computer. Generally, program modules include routines, programs, objects, applications, components, data structures, etc., that perform particular tasks or implement particular abstract data types. For example, a server may comprise a single server or a group of servers used to service users. Additionally, a server may comprise a front-end web server and a back-end database server. Alternatively, those functions can be integrated into a single server device.

Those skilled in the art will appreciate that the invention may be practiced with various computer system configurations, including hand-held wireless devices such as mobile phones, tablets or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Computing devices (e.g., mobile devices, lap-tops, desk-tops, etc.) typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as the Macintosh®OS or Apple iOS operating systems, Google Android operating system (and variations thereof), Microsoft Windows® operating system (desktop and/or mobile version), the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Apache™ operating system, an OpenStep™ operating system or another operating system or platform.

User applications may be so-called stand-alone applications executing on user devices or they may be client-server type applications that interface with server-side components. They may include applications provided by the server, such as Java Applets, that may be delivered with web pages.

The memory will include at least one set of instructions that is either permanently or temporarily stored. The processor executes the instructions that are stored in order to process data. The set of instructions may include various instructions that perform a particular task or tasks, such as those shown in the appended flowchart. Such a set of instructions for performing a particular task may be characterized as a program, software program, software, engine, module, component, mechanism, or tool. The computer may include a plurality of software processing modules stored in a memory as described herein and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, RUM and/or JavaScript, for example. Further, it is not necessary that a single type of instruction or programming language be utilized in conjunction with the operation of the system and method of the invention. Rather, any number of different programming languages may be utilized as is necessary or desirable.

In addition, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media is typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, processor, CPU (Central Processing Unit), programmed micro-processor, micro-controller, peripheral integrated circuit element, a CSIC (Visitor Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It is appreciated that in order to practice the invention as described herein, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described herein is performed by various components and various memories. However, it is appreciated that the processing performed by two distinct components as described herein may, in accordance with a further embodiment of the invention, be performed by a single component. Further, the processing performed by one distinct component as described herein may be performed by two distinct components. In a similar manner, the memory storage performed by two distinct memory portions as described herein may, in accordance with a further embodiment of the invention, be performed by a single memory portion. Further, the memory storage performed by one distinct memory portion as described herein may be performed by two memory portions, for example.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. Input devices include those that recognize hand movements or gestures, such as in the case of gesture set supported by Android or the swipe movements recognized in iOS-based devices. These and other input devices are often connected to the processing unit through a user input interface that is coupled to the system bus, but may be connected by other interface and bus structures, such as a parallel port, game port or a universal serial bus (USB).

A user interface may include any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed herein, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the invention, it is not necessary that a human user actually interact with a user interface used by the processing machine of the invention. Rather, it is also contemplated that the user interface of the invention might interact, i.e., convey and receive information, with another processing machine, rather than a human user. Further, it is contemplated that a user interface utilized in the invention may interact partially with another processing machine or processing machines, while also interacting partially with a human user.

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described herein.

Various networks may be implemented in accordance with embodiments of the invention, including a wired or wireless local area network (LAN) and a wide area network (WAN), the Internet, wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism.

Computers may be connected over the Internet, an Intranet, Extranet, Ethernet, or any other system that provides communications. Some suitable communications protocols may include TCP/IP, UDP, or OSI, for example. For wireless communications, communications protocols may include Bluetooth, Zigbee, IrDa, Wi-Fi, 2G, 3G, Ultra-Wideband and Long Term Evolution (LTE) or other suitable protocols. The wireless communications protocol may also include short-range communications devices and protocols, such as RFID, or Near-Field Communication radio transmissions. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

Specifically, the system 500 may comprise a compliance processor 502, a payment database 504, and a rules database 506 for maintaining travel rules. In operation, the compliance processor 502 may be in communication with various payment data channels to receive payment orders. For example, compliance processor 502 may be coupled to a web server 508 and/or banking database 509. Using various types of personal computing devices including mobile devices, Internet banking customers 510 may access a web portal hosted by the web server 508 to submit payment orders. The web server 508 may either submit the payment orders (piecemeal or in batches) to the compliance processor 502 or may call up the screening functionality provided by the compliance processor 502 to capture non-compliant payment data as they are being entered by the customers 510 on the web portal. The compliance processor 502 may also be in communication with a banking branch 512 and receive incoming payment orders from its branch office computer system. The compliance processor 502 may further receive payment orders from other channels such as money transfer stores or websites (e.g., MoneyGram and Western Union) and bulk payment processors.

The compliance processor 502 may store the incoming payment orders in the payment database 504 and screen them in piecemeal or batch process based on the travel rules maintained in the rules database 506, as described above. The non-compliant payment orders may be returned to the ordering party for correction or corrected by the compliance processor 502 or other computer system. Compliant payment orders may be forwarded on to the destination bank 516 for execution.

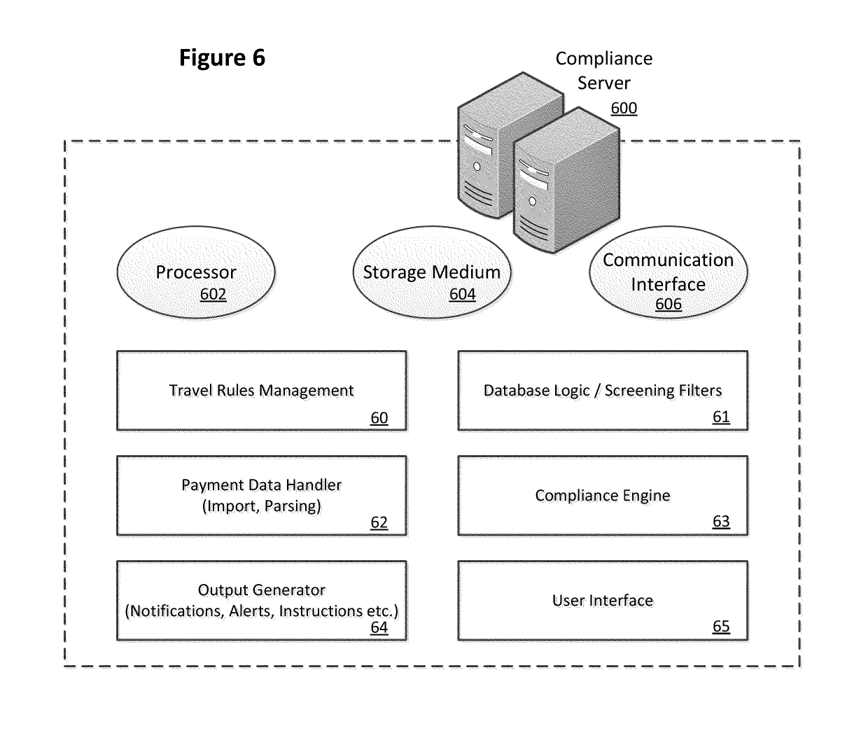

FIG. 6 is a block diagram illustrating an exemplary compliance server (or compliance processor) 600 in accordance with one embodiment of the present invention. In terms of hardware, the compliance server 600 may comprise a processor 602, a storage medium 604, and a communication interface 606. In terms of software, the compliance server 600 may include or run a number of functional modules such as Travel Rules Management 60, Database Logic/Screening Filters 61, Payment Data Handler 62, Compliance Engine 63, Output Generator 64, and User Interface 65. Although these functions are shown here as discrete modules, those skilled in the art may appreciate that at least some of these functions may be merged together or further divided into finer modules without substantively changing the intended effects.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention. The various embodiments and features of the presently disclosed invention may be used in any combination, as the combination of these embodiments and features are well within the scope of the invention. While the foregoing description includes many details and specificities, it is to be understood that these have been included for purposes of explanation only, and are not to be interpreted as limitations of the present invention. It will be apparent to those skilled in the art that other modifications to the embodiments described herein can be made without departing from the spirit and scope of the invention. Accordingly, such modifications are considered within the scope of the invention as intended to be encompassed by the following claims and their legal equivalents.

What is claimed is:

1. A computer-implemented method for capturing non-compliant payment orders, the method comprising:
compiling, into an electronic database, a plurality of travel rules governing requisite information of payments to at least one foreign jurisdiction;
receiving, by at least one computer processor, payment data concerning a payment order, the payment order requesting a payment from an ordering party to a beneficiary;
determining, by the at least one computer processor, whether the payment data comply with the plurality of travel rules, the determining further comprising at least one of:
determining, in the payment data, a presence or absence of one or more data elements required by at least one of the plurality of travel rules, and
determining whether a data element in the payment data meets a content or formatting requirement of at least one of the plurality of travel rules; and
generating an output based on the step of determining whether the payment data comply with the plurality of travel rules.

2. The computer-implemented method of claim 1, further comprising:
generating the output if the payment data fail to comply with at least one of the plurality of travel rules.

3. The computer-implemented method of claim 2, further comprising:
generating a notification of non-compliance to the ordering party.

4. The computer-implemented method of claim 3, further comprising:
generating a suggestion or instruction for the ordering party to correct at least some of the non-compliant payment data.

5. The computer-implemented method of claim 3, further comprising:
proceeding to process the payment order.

6. The computer-implemented method of claim 5, wherein the payment order is processed if the ordering party fails to correct the non-compliant payment data.

7. The computer-implemented method of claim 2, further comprising:
automatically revising, by the at least one computer processor, at least some of the non-compliant payment data.

8. The computer-implemented method of claim 2, further comprising:
rejecting or canceling the non-compliant payment order.

9. The computer-implemented method of claim 1, further comprising:
updating the electronic database with additional or revised travel rules governing the requisite information of payments to the at least one foreign jurisdiction.

10. The computer-implemented method of claim 1, further comprising:
generating a report of non-compliant payment orders captured by the computer-implemented method to demonstrate compliance of a payment processor with the plurality of travel rules.

11. The computer-implemented method of claim 1, further comprising:
examining, by the at least one computer processor, each data element in the payment data against all relevant travel rules.

12. The computer-implemented method of claim 1, wherein the output comprises a compliance score or rating based on detected non-compliance of the payment data.

13. A computer-implemented system for capturing non-compliant payment orders, the system comprising:
at least one computer processor;
at least one storage medium; and
at least one communication interface;
the at least one computer processor being configured to perform the following:
compiling, into at least one storage medium, a plurality of travel rules governing requisite information of payments to at least one foreign jurisdiction;
receiving payment data concerning a payment order, the payment order requesting a payment from an ordering party to a beneficiary;
determining whether the payment data comply with the plurality of travel rules, the determining further comprising at least one of:
determining, in the payment data, a presence or absence of one or more data elements required by at least one of the plurality of travel rules, and
determining whether a data element in the payment data meets a content or formatting requirement of at least one of the plurality of travel rules; and
generating an output based on the step of determining whether the payment data comply with the plurality of travel rules.

14. A non-transitory computer readable medium containing computer readable code for capturing non-compliant payment orders, the computer readable code being configured to cause at least one processor to perform the following:
receiving payment data concerning a payment order involving a foreign jurisdiction;
retrieving a plurality of travel rules governing requisite information of payments involving the foreign jurisdiction;
determining whether the payment data comply with the plurality of travel rules, the determining further comprising at least one of:
determining, in the payment data, a presence or absence of one or more data elements required by at least one of the plurality of travel rules, and
determining whether a data element in the payment data meets a content or formatting requirement of at least one of the plurality of travel rules; and
generating an output based on the step of determining whether the payment data comply with the plurality of travel rules.
